(19) United States
(12) Patent Application Publication
(10) Pub. No.: US 2008/0043036 A1
(43) Pub. Date: Feb. 21, 2008

(54) METHOD, APPARATUS AND COMPUTER PROGRAM FOR PRESENTING CASES COMPRISING IMAGES

(75) Inventors: Carl J. G. Evertsz, Bremen (DE); Anke Bodicker, Bremen (DE)

Correspondence Address: SEED INTELLECTUAL PROPERTY LAW GROUP PLLC, 701 FIFTH AVE, SUITE 5400, SEATTLE, WA, 98104, US

(73) Assignee: MEVIS BREASTCARE GMBH & CO. KG, Bremen (DE)

(21) Appl. No.: 11/465,078

(22) Filed: Aug. 16, 2006

(51) Int. Cl. G09G 5/00

(52) U.S. Cl. 345/629

(57) ABSTRACT

A method and apparatus presents cases comprising images, wherein selection values are provided, which are assigned to the cases and which are determined from the images of the respective case, wherein the presentation of the cases depends on the selection values. The sorting values are determined depending on the selection values, wherein a case list is generated by sorting the cases according to the determined sorting values and wherein the cases are presented in accordance with the generated case list. The cases can be medical cases, wherein the images are medical images, in particular mammograms, and wherein the sorting value is a measure for the difficulty of evaluating the case and/or the probability of showing an illness.

### TECHNICAL FIELD

This disclosure generally relates to a method, apparatus and computer program for presenting cases comprising images.

### BACKGROUND INFORMATION

Cases comprising images, in particular, medical cases comprising medical images, are normally presented in a table and the images, which belong to the cases, can be reviewed in the sequence, in which the cases are arranged within the table. The cases within the table can be sorted, for example, with respect to the name of a patient or a patient ID. It also exists the possibility for a user, like a radiologist, to select a certain case within the table and to review this certain case.

This presentation of the cases comprising images, in particular, the sequence, in which they are presented, depends only on administrative features, like a patient name or patient ID. A presentation of the cases, which takes into account features of the images of the cases, is not possible. But, such a presentation would, for example, allow to review cases having images with similar features directly one after another, wherein these cases could be easily compared.

### BRIEF SUMMARY OF THE INVENTION

Embodiments of the present invention provide a method, an apparatus and a computer program for presenting cases comprising images, wherein the presentation of the case is determined by the images of the case.

In a first aspect of the present invention a method for presenting cases comprising images is presented, wherein selection values are provided, which are assigned to the cases and which are determined from the images of the respective case, wherein the presentation of the cases depends on the selection values.

One embodiment of the invention is based on the idea that selection values are provided, which are determined from the images of the respective case, e.g., which depend on the images of the respective case. Therefore, since the presentation of the cases depends on the selection values, the presentation of the cases depends on the images of the respective case.

This case is, for example, a medical case, comprising medical images, and the selection values can be values, which have been determined by using computer-aided-detection algorithms (CAD algorithms). These CAD algorithms are, for example, used by CAD devices, which generate a DICOM CAD Structure Report (SR), which contains values, which have been determined from the images of the cases. These values are, in particular, the selection values. These values are, for example, the number of microcalcification clusters, the number of masses, the centres of microcalcification clusters, the centres of masses, the outline of a mass, the number of calcifications per microcalcification cluster, the size of a mass, the size of a microcalcification cluster, the breast density, the breast composition, and the suspiciousness or certainty of finding.

It is preferred in one embodiment that sorting values are determined depending on the selection values, wherein a case list is generated by sorting the cases according to the determined sorting values and wherein the cases are presented in accordance with the generated case list. A sorting value can, for example, be determined as a combination of the selection values, or a sorting value can directly be a selection value. This allows to present the cases in a sorted way, wherein the sorting order indirectly depends on the images of the cases.

It is further preferred in one embodiment, that the cases are medical cases, wherein the images are medical images, in particular mammograms, and wherein the sorting value is a measure for the difficulty of evaluating the cases and/or the probability of showing an illness. Since, in this embodiment, the cases are sorted with respect to the difficulty of evaluating the cases and/or the probability of showing an illness, in particular, of showing cancer, the medical cases can be ordered and presented in the sequence such that is suits to the user, for example, a radiologist, who wants to evaluate or review the medical cases. It is, for example, preferred in one embodiment to generate the case list such that the corresponding sorting values are decreasing or increasing. If the sorting value is a measure for the difficulty of evaluating the cases and/or the probability of showing an illness, the cases can, for example, be presented such that at first the cases are shown, which are more difficult, and that easier cases are shown later. Such a sequence can, for example, be used, if the user, like a radiologist, has in the beginning of the evaluating process a higher level of attention than at the end of the evaluating process. A further advantage of a decreasing or increasing sequence is that the complexity of the cases does not change abruptly, which could help the user to maintain a certain level of attention during reviewing or evaluating the cases. It is also preferred in one embodiment that the case list is generated such that the corresponding sorting values are evenly distributed, e.g., preferentially as evenly as possible in one embodiment.

The sorting values are, for example, the probability of malignancy, the number of CAD marks per case, the number of mass marks per case, the number of cluster marks per case, the number of mass marks containing microcalcifications per case, the number of calcifications marks within a cluster of microcalcifications, in particular, the highest number of calcifications marks within a cluster of microcalcifications in a case, or the breast density.

The breast density can, for example, comprise one of the values 1 to 4, wherein the value of “1” defines that the breast is almost entirely fat, the value of “2” defines that there are scattered fibroglandular densities, the value of “3” defines that the breast tissue is heterogeneously dense, and the value of “4” defines that the breast tissue is extremely dense. These numbers are also known as ACR BIRADS categories.

It is further preferred in one embodiment that the presentation of cases comprises displaying a table in a table presentation area, wherein the table presentation area comprises a sorting button, wherein the method as claimed in claim 2 is started by activating the sorting button and wherein the table includes the cases and the selection values and/or the sorting values sorted in accordance with the generated case list. Since also the selection value and/or the sorting values are included in the table, a user can directly see why the cases are ordered in this way. Furthermore, the user can check, whether the cases are sorted with respect to a desired selection value and/or sorting value.

It is further preferred in one embodiment that the presentation of cases comprises displaying a table in a table presentation area, wherein the table presentation area comprises a sorting button, wherein a sorting measure selecting menu is displayed for selecting at least one sorting measure by activating the sorting button, wherein the sorting measure selecting menu comprises an apply button and wherein the method as claimed in claim 2 is started by activating the apply button, wherein sorting values are determined which correspond to the selected sorting measures, wherein the table includes the cases and the selection values and/or the sorting values sorted in accordance with the generated case list. Since a sorting measure selecting menu is used for selecting a sorting measure, a sorting measure can easily be selected, for example, by using an input device, like a keyboard or a mouse.

It is further preferred in one embodiment that the sorting measure selecting menu comprises fields for selecting, whether the case list is generated such that the corresponding sorting values are decreasing or increasing. This allows a user to easily select a decreasing or increasing case list.

It is further preferred in one embodiment that the table presentation area comprises a complexity button, wherein the method as claimed in claim 5 is started by activating the complexity button and wherein the table includes the cases and the selection values and/or the sorting values sorted in accordance with the generated case list. This allows a user to easily generate the case list such that the corresponding sorting values are evenly distributed, and, since the table also includes the selection values and/or the sorting values, this allows the user also to check, whether the cases are evenly distributed with respect to the sorting values in the present table.

It is further preferred in one embodiment that the presentation of cases comprises displaying the images of the cases temporally successively in accordance with the generated case list in an image presentation area, e.g., only images of one case are presented at the same time and the images of different cases are temporally successively presented in accordance with the generated case list.

It is further preferred in one embodiment that restriction values are determined depending on the selection values, wherein only cases are presented, whose restriction values fulfill a given restriction condition. The restriction values can, for example, directly be the selection values or a combination of the selection values. A restriction condition can, for example, be that only cases are presented, which have a certain restriction value and/or selection value. The cases are preferentially medical cases in one embodiment, wherein the images are medical images, in particular mammograms, and wherein the restriction value is preferentially in one embodiment a measure for the difficulty of evaluating the cases and/or the probability of showing an illness, in particular, of showing cancer. This restriction value can, for example, be the suspiciousness, which is contained in a SR. The restriction condition can, for example, be that only cases are shown, which have a restriction value, which is a measure for the difficulty of evaluating the case and which is lower than a predetermined threshold, e.g., that only easy cases are presented, e.g., cases with a very low probability of cancer. This restriction can, for example, be useful, if a radiologist is tired or if a young radiologist with not much experience in reading the cases wants to read some easy cases. It is also preferred in one embodiment that only cases are presented having a restriction value, which is a measure for the difficulty of evaluating the case and which is larger than a predetermined threshold, e.g., that only cases are presented, which are above a certain difficulty level. This can, for example, be used, if a senior radiologist with a lot of experience in reading cases wants to read some very difficult cases, for example, cases comprising mammograms of patients with very dense breasts.

It is preferred in one embodiment that the presentation of cases comprises displaying a table in a table presentation area, wherein the table presentation area comprises a restriction button, wherein the method as claimed in claim 11 is started by activating the restriction button and wherein the table includes the cases, whose restriction values fulfill the given restriction condition, and the corresponding selection values and/or restriction values. It is further preferred in one embodiment that the presentation of cases comprises displaying a table in a table presentation area, wherein the table presentation area comprises a restriction button, wherein a restriction measure selecting menu is displayed for selecting at least one restriction measure by activating the restriction button, wherein the restriction measure selecting menu comprises an apply button and wherein the method as claimed in claim 11 is started by activating the apply button, wherein restriction values are determined which correspond to the selected restriction measures, wherein the table includes the cases, whose restriction values fulfill the given restriction condition, and the corresponding selection values and/or restriction values. This allows to easily select a desired restriction.

It is further preferred in one embodiment that the presentation of cases comprises displaying the images of the cases, whose restriction values fulfill the given restriction condition, temporally successively in an image presentation area.

It is further preferred in one embodiment that the cases are medical cases, wherein the images are medical images, in particular mammograms, and wherein the selection values are at least on of breast density, architectural noise, number of mass marks, number of microcalcification marks, number of calcified masses, number of calcifications in a cluster, suspiciousness, number of CAD markers, number of microcalcification clusters, size of a mass marker, size of a microcalcification cluster, size of a calcified mass.

Further embodiments of the invention are defined in the dependent claims.

In a further aspect of the present invention an apparatus for presenting cases comprising images is presented, wherein selection values have been provided, which are assigned to the cases and which have been determined from the images of the respective case, wherein the apparatus comprises a presentation unit, and wherein the apparatus is adapted for presenting the cases depending on the selection values on the presentation unit.

It is preferred that one embodiment of the apparatus comprises:
a sorting values determination unit for determining sorting values depending on the selection values,
a case list generation unit for generating a case list by sorting the cases according to the determined sorting values, wherein the apparatus is adapted for presenting the cases in accordance with the generated case list on the presentation unit.

It is further preferred in one embodiment that the cases are medical cases, wherein the images are medical images, in particular mammograms, and wherein the sorting value is a measure for the difficulty of evaluating the cases and/or the probability of showing an illness.

It is further preferred in one embodiment that the case list generation unit is adapted for generating the case list such that the corresponding sorting values are decreasing or increasing.

It is further preferred in one embodiment that the case list generation unit is adapted for generating the case list such that the corresponding sorting values are evenly distributed.

It is further preferred in one embodiment that the presentation unit is adapted for displaying a table in a table presentation area, wherein the table presentation area comprises a sorting button, wherein the method as claimed in claim 2 is started by activating the sorting button and wherein the table includes the cases and the selection values and/or the sorting values sorted in accordance with the generated case list.

It is further preferred in one embodiment that the presentation unit is adapted for displaying a table in a table presentation area, wherein the table presentation area comprises a sorting button, wherein a sorting measure selecting menu is displayed for selecting at least one sorting measure by activating the sorting button, wherein the sorting measure selecting menu comprises an apply button and wherein the method as claimed in claim 2 is started by activating the apply button, wherein sorting values are determined which correspond to the selected sorting measures, wherein the table includes the cases and the selection values and/or the sorting values sorted in accordance with the generated case list.

It is further preferred in one embodiment that the sorting measure selecting menu comprises fields for selecting, whether the case list is generated such that the corresponding sorting values are decreasing or increasing.

It is further preferred in one embodiment that the table presentation area comprises a complexity button, wherein the method as claimed in claim 5 is started by activating the complexity button and wherein the table includes the cases and the selection values and/or the sorting values sorted in accordance with the generated case list.

It is further preferred in one embodiment that the apparatus is adapted for displaying the images of the cases temporally successively in accordance with the generated case list in an image presentation area on the presentation unit.

It is further preferred in one embodiment that the apparatus is adapted for determining restriction values depending on the selection values, wherein the presentation unit is adapted for presenting only cases whose restriction values fulfill a given restriction condition.

It is further preferred in one embodiment that the cases are medical cases, wherein the images are medical images, in particular mammograms, and wherein the restriction value is a measure for the difficulty of evaluating the cases and/or the probability of showing an illness.

It is further preferred in one embodiment that the presentation unit is adapted for displaying a table in a table presentation area, wherein the table presentation area comprises a restriction button, wherein the method as claimed in claim 10 is started by activating the restriction button and wherein the table includes the cases, whose restriction values fulfill the given restriction condition, and/or the corresponding selection values and/or restriction values.

It is further preferred in one embodiment that the presentation unit is adapted for displaying a table in a table presentation area, wherein the table presentation area comprises a restriction button, wherein a restriction measure selecting menu is displayed for selecting at least one restriction measure by activating the restriction button, wherein the restriction measure selecting menu comprises an apply button and wherein the method as claimed in claim 11 is started by activating the apply button, wherein restriction values are determined which correspond to the selected restriction measures, wherein the table includes the cases, whose restriction values fulfill the given restriction condition, and/or the corresponding selection values and/or restriction values.

It is further preferred in one embodiment that the apparatus is adapted for displaying the images of the cases, whose restriction values fulfill the given restriction condition, temporally successively in an image presentation area.

It is further preferred in one embodiment that the cases are medical cases, wherein the images are medical images, in particular mammograms, and wherein the selection values are at least one of breast density, architectural noise, number of mass marks, number of microcalcification marks, number of calcified masses, number of calcifications in a cluster, suspiciousness, number of CAD markers, number of microcalcification clusters, size of a mass marker, size of a microcalcification cluster, size of a calcified mass.

It is further preferred in one embodiment that the apparatus is adapted for displaying the images of the cases on the presentation unit, wherein the images preferentially comprise marks.

It is further preferred in one embodiment that the apparatus comprises:
a sorting value determination unit for determining sorting values depending on the appearance of the images of a case,
a case list generating unit for generating a case list by sorting the cases according to the determined sorting values, wherein the apparatus is adapted for presenting the cases in accordance with the generated case list.

In a further aspect of the present invention an imaging system is presented, comprising:
a case generation unit for generating cases, in particular, a digital mammography device,
a selection value generation unit for generating selection values, in particular, computer-aided-detection device,
apparatus for presenting cases comprising images disclaimed in claim 19. In a further aspect of the present invention a computer program for presenting cases comprising images is provided, wherein the computer program comprises program code means for causing a computer to carry out the steps of the method as claimed in claim 1 when said computer program is carried out on a computer controlling the apparatus as claimed in claim 19.

It shall be understood that the method of claim 1, the apparatus of claim 19, the imaging system of claim 24 and the computer program of claim 25 have corresponding embodiments as defined in the dependent claims.

### BRIEF DESCRIPTION OF THE SEVERAL VIEWS OF THE DRAWINGS

These and other aspects of the invention will be apparent from and elucidated with reference to the non-limiting and non-exclusive embodiments described herein after. In the following drawings:

FIG. 1 shows schematically an embodiment of an image system in accordance wit the invention,

FIG. 2 shows schematically an embodiment of an apparatus for presenting cases comprising images in accordance with the invention,

FIG. 3 shows a flowchart of an embodiment of a method for presenting cases comprising images in accordance with the invention,

FIG. 4 shows exemplarily a table for presenting cases displayed on a presentation unit,

FIG. 5 shows exemplarily a sorting measure selecting menu displayed on the presentation unit, and

FIG. 6 shows exemplarily a restriction measure selecting menu displayed on the presentation unit.

### DETAILED DESCRIPTION OF EMBODIMENTS

In the following description, numerous specific details are given to provide a thorough understanding of embodiments. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The headings provided herein are for convenience only and do not interpret the scope or meaning of the claimed invention.

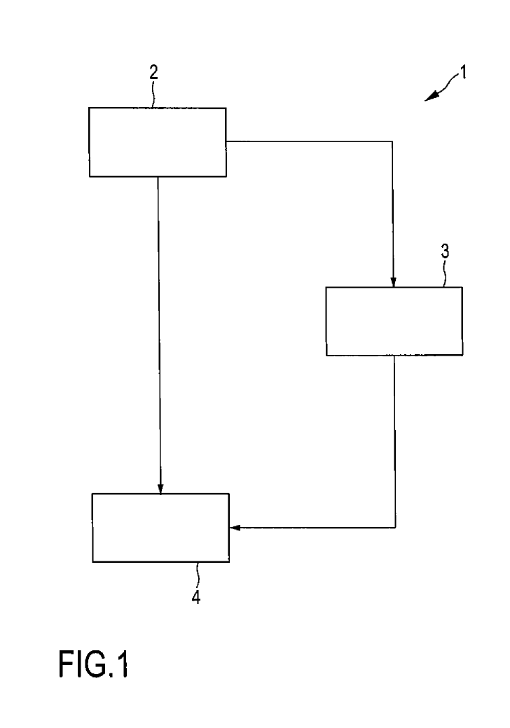

FIG. 1 shows schematically an imaging system 1 comprising a case generation unit 2 for generating cases. The case generation unit 2 is, for example, a digital mammography device, a computed tomography device, a magnetic resonance imaging device, an ultra sound device or any other medical imaging device. The case generation unit 2 acquires images and groups these images, wherein each group is assigned to a case. For example, if the case generation unit 2 is a medical imaging device acquiring medical images, like digital mammograms, the case generation unit 2 can be adapted such that images of a patient, which have been acquired during a predetermined time interval, are assigned to one case. A case can, for example, comprise images of a patient, which have been acquired at a certain day.

In one preferred embodiment, the case generation unit 2 is a digital mammography device. In mammography each breast is generally imaged twice, e.g., a craniocaudal view (CC) image and a mediolateral oblique view (MLO) image are acquired. Therefore, the images of a medical case are preferentially in one embodiment a right MLO image, a left MLO image, a right CC image and a left CC image. It is preferred in one embodiment that each case comprises these four images.

A case is preferentially identified in one embodiment by a patient name, a patient ID or an acquisition date or a combination of the patient name and/or the patient ID and/or the acquisition date.

The cases comprising images are transferred from the case generation unit 2 to a selection value generation unit 3. The selection value generation unit 3 is preferentially in one embodiment a computer-aided-detection device (CAD device), which uses CAD algorithms and determines a DICOM CAD Structure Report (SR) from the images of the cases. Preferentially in one embodiment, for each image of a case a SR is determined. The SR contains a lot of values, which are defined in the DICOM standard. The DICOM standard and, in particular, the SR are, for example, disclosed in Digital Imaging and Communication and Medicine (DICOM) 2006, published by the ACR (the American College of Radiology) and the NEMA (The National Electrical Manufacturers Association), in particular, in DICOM Base Standard 2006 Part PS 3.16; Supplement 50: Mammography Computer-Aided Detection SR SOP.

The selection values are preferentially in one embodiment the values of the SR, in particular, the breast density, the breast composition, the architectural noise, the number of mass marks, the number of microcalcification marks, the number of calcified methods, the number of calcification in a cluster, the suspiciousness or the certainty of finding, the number of CAD marks, the number of microcalcification clusters, the size of a mass marker, the size of a microcalcification cluster and the size of the calcified masses.

In mammograms the architectural noise is a seemingly random pattern, which is formed by various tissues in the breast (ducts, lobules, fat and connective tissue). In a fatty breast, the ducts, lobules and connective tissues are mostly absent. A tumour thus stands-out against a rather smooth “fatty background” with no architectural noise. Therefore, such a mammogram is easy to read. In a mammogram with lots of architectural noise, the projection and superposition of connective tissue, lobules and ducts can create the impression of a spiculated mass in place where there is non. These mammograms are rather hard to read, while the radiologist has to try to distinguish between real lesions and projection artifacts. In the science of image analysis there are various measures for noise (entropy, Fourier power spectrum, fractal dimension etc.). In combination with some image processing, such as edge enhancement of linear structures etc., these mathematical concepts are preferentially used in one embodiment to quantify architectural noise in mammograms.

The selection values, which are, in this embodiment, the values of the SR and which have been determined by the selection value generation unit 3, are transferred from the selection value generation unit 3 to an apparatus 4 for presenting cases. In addition, the cases are transferred from the case generation unit 2 to the apparatus 4 for presenting cases. The apparatus 4 for presenting cases is adapted to present the cases depending on the selection values. This presentation of the cases in dependence on the selection values will be described in more detail further below.

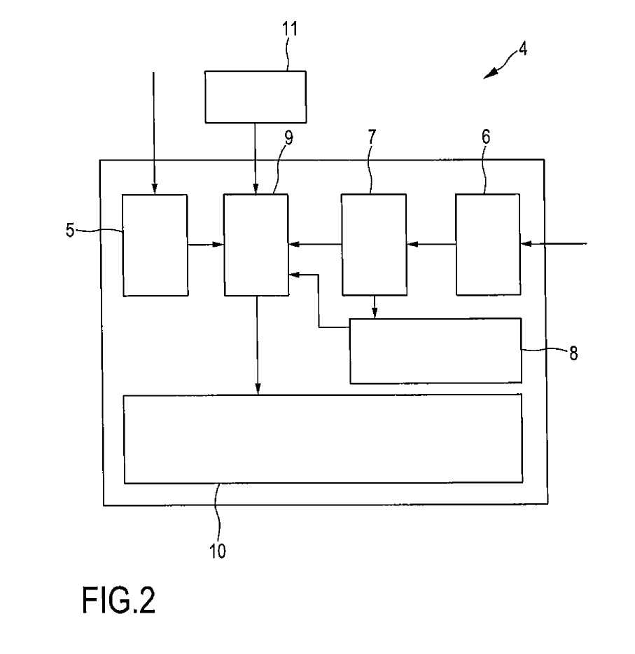

FIG. 2 shows schematically an embodiment of the apparatus 4 for presenting cases in more detail. The apparatus 4 for presenting cases comprises a case receiving unit 5 for receiving cases from the case generation unit 2. The apparatus 4 for presenting cases comprises further a selection value receiving unit 6 for receiving selection values from the selection value generation unit 3. Since, in this embodiment, the selection value generation unit 3 generates SRs, which contain the selection values, the selection value receiving unit 6 receives selection values by receiving SRs and by extracting the selection values from the SRs. The selection values are transferred to a sorting value determination unit 7. The sorting value determination unit 7 generates for each case a sorting value, which depends on the selection values of the images of the respective case.

In this embodiment, the selection value generation unit 3 generates SRs. A SR comprises for each image of a case CAD marks and values, which define the CAD marks. For example, following values can be extracted from the SRs of the images of a certain case: the highest breast density value within the case, the highest suspiciousness of a CAD mark within the images of the case, the number of CAD marks within the images of the case, the number of microcalcification groups within the images of the case, the number of masses within the images of the case, the number of calcified masses within the images of the case and the number of calcifications within clusters. One or a combination of these values is preferentially in one embodiment a sorting value of the certain case. If the images of the case comprise several calcification clusters, the sorting value can be the highest number of calcifications present within on of these calcification clusters.

The sorting values are transferred from the sorting value determination unit 7 to a case list generation unit 8. The case list generation unit 8 generates a case list by sorting the cases according to the determined sorting values. The generated case list is transferred to a control unit 9, which also receives the cases from the case receiving unit 5. The control unit 9 controls a presentation unit 10 such that the cases are presented in accordance with the generated case list.

The presentation unit is preferentially a monitor in one embodiment. A user can enter inputs into the apparatus 4 for presenting cases by using an input unit 11, which is, for example, a keyboard or a mouse.

The apparatus 4 for presenting cases can also be adapted such that restriction values are determined for each case and that only cases are presented whose restriction values fulfill a given restriction condition. For example, in this embodiment, the restriction values are the sorting values, which can be transferred from the sorting determination unit 7 to the control unit 9. A restriction condition is preferentially that a restriction value, e.g., in this embodiment, a sorting value, is above or below a given threshold. This restriction condition can preferentially be configured in one embodiment by a user via the input unit 11. If this restriction feature is used, only cases are presented, which fulfill the respective restriction condition. The apparatus 4 for presenting cases can be adapted such that the restricted cases are presented in accordance with the generated case list. But, in accordance with the invention, the apparatus 4 for presenting cases can also be adapted such that the restricted cases are not presented in accordance with a generated case list.

The selection value generation unit 3 and the apparatus for presenting cases 4 are preferentially computer systems in one embodiment. The case receiving unit 5, the selection value receiving unit 6, the sorting value determination unit 7, the case list generation unit 8 and the control unit 9 can be realized by program code means and/or dedicated hardware. The invention is not limited to these different units of the apparatus 4 for presenting cases. It is also possible that other kinds of units are used, as long as the apparatus 4 for presenting cases still presents the cases in dependence on the selection values. For example, the sorting value determination unit 7 and the case list generation unit 8 can be combined into one unit being a program code means. Furthermore, the case receiving unit 5 and the selection value receiving unit 6 could be combined to one single receiving unit receiving both, the cases and the selection values, e.g., in this embodiment, the SRs.

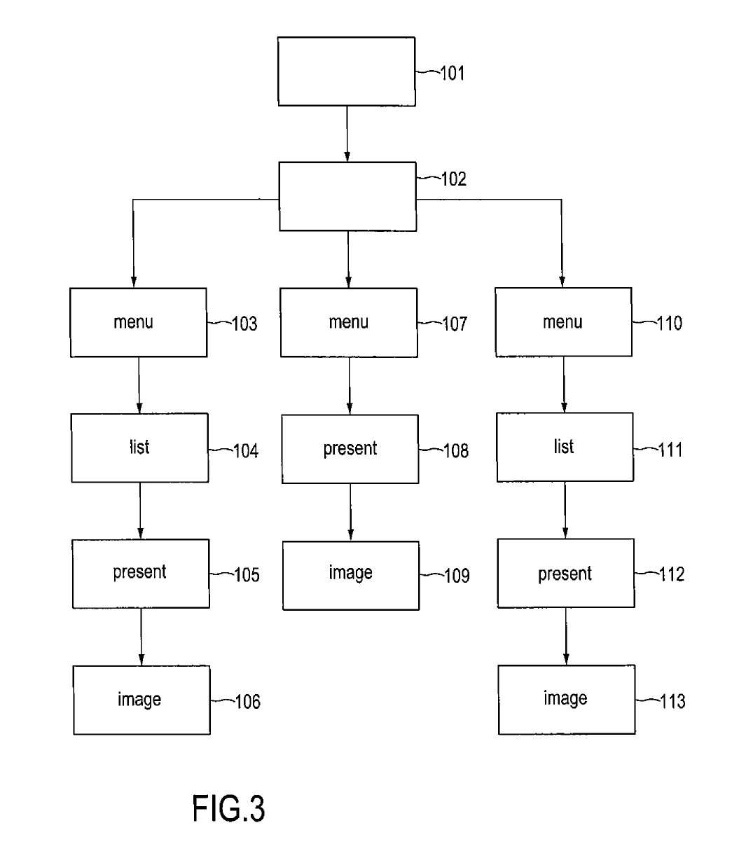

An embodiment of a method for presenting cases comprising images in accordance with the invention will now be described in more detail with respect to a flowchart shown in FIG. 3.

In step 101 the case generation unit 2 acquires cases and transfers these case to the selection value generation unit 3 and to the apparatus 4 for presenting cases. The selection value generation unit 3 generates selection values, in this embodiment, SRs containing selection values. The selection values are transferred from the selection value generation unit 3 to the apparatus 4 for presenting cases. Thus, cases and selection values, which are assigned to the cases, are provided to the apparatus 4 for presenting cases. If, in other embodiments, the cases and the assigned selection values have already been provided to the apparatus 4 for presenting cases, step 101 can be omitted.

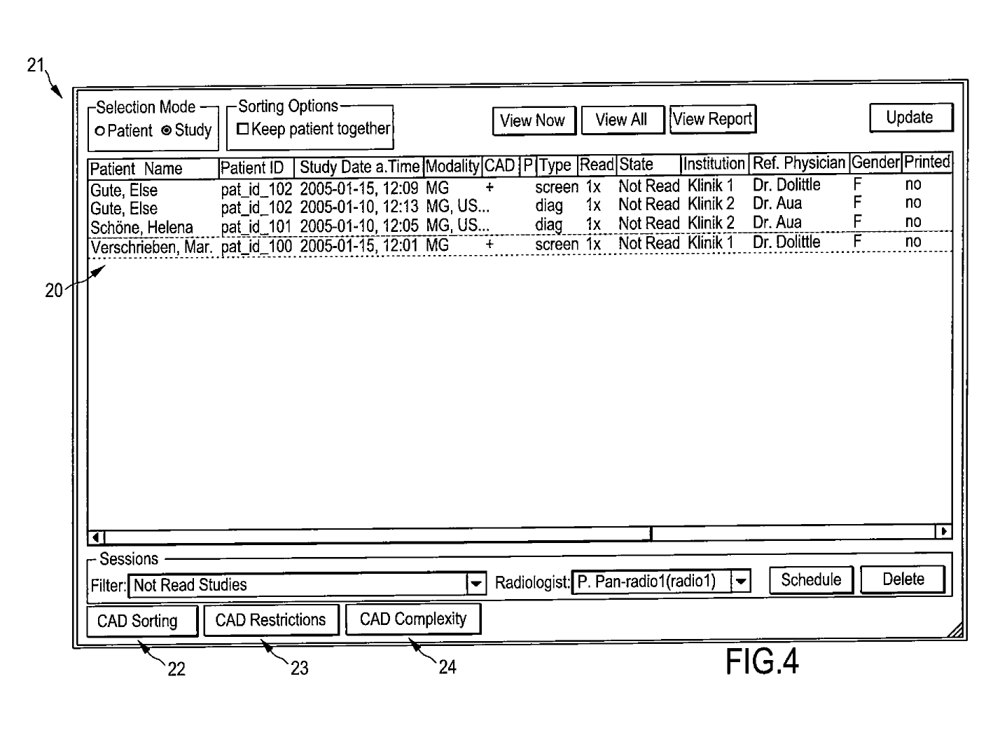

In step 102 the cases are presented on the presentation unit 10, for example, on a monitor of the apparatus 4 for presenting cases. This presentation of the cases is exemplarily shown in FIG. 4.

FIG. 4 shows exemplarily a table 20, in which four cases are listed. The table 20 contains a patient name, a patient ID, a study date and time, a modality, a CAD indication, a protection indication, a type indication, a read indication, a state indication, an institution, a referring physician, a gender and a printed indication. The table can contain even more information, in particular, it can contain the selection values and/or the restriction values and/or the sorting values of the cases. The study date and time column in the table 20 defines the date and the time, at which the images of the case have been acquired. The modality column defines the modality, which has been used to acquire the images of the case. MG describes, for example, a mammography device, and US describes an ultrasound device. The CAD indication indicates, whether for this case CAD marks are available, e.g., whether selection values are available for this case. The P column indicates a protection of the case. If a case has been protected, it can not be removed. The type indication indicates, whether the respective case is a screening case or a diagnostic case. The read indication indicates, how often the respective case should be reviewed. The state indication indicates, how often the respective case has been read and preferentially in one embodiment whether the diagnostic results of different reviews, for example, reviews by different radiologists, are equal or differ from each other. The institution column indicates the institution, at which the images of the respective case have been acquired. The printed column indicates, whether a diagnostic report has already been printed for the respective case.

The table 20 is displayed within a table presentation area 21, which also comprises a CAD sorting button 22, a CAD restriction button 23 and a CAD complexity button 24.

If the CAD sorting button 22 is pressed, for example, by using a mouse pointer and a mouse being the input unit 11 in this embodiment, the method continues with step 103.

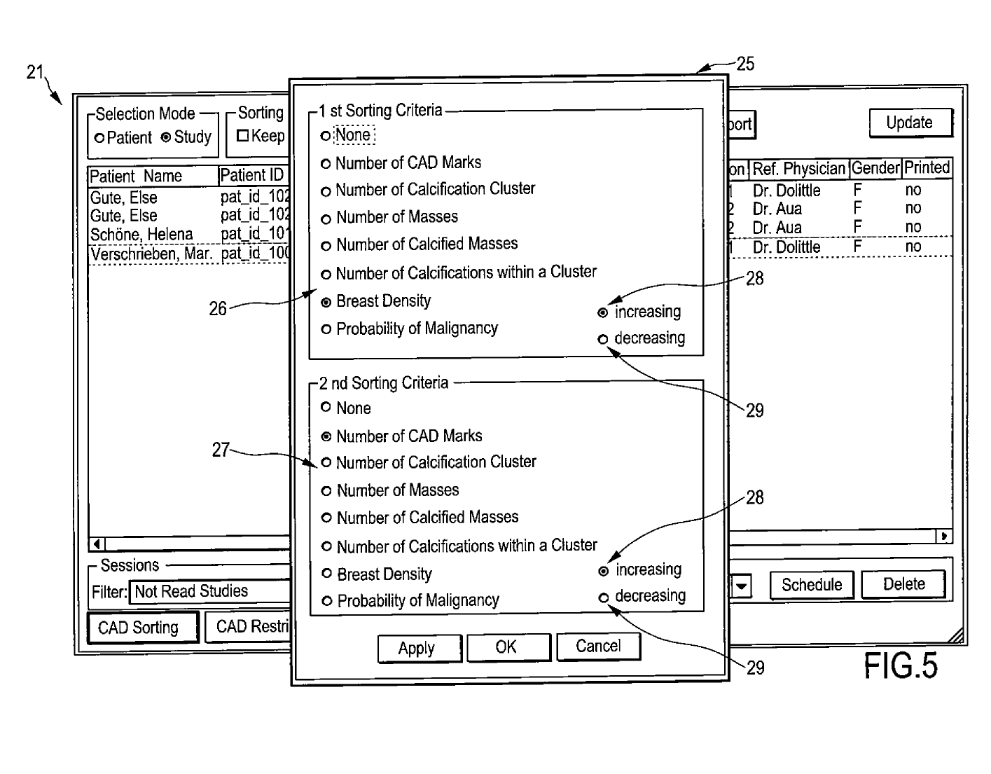

In step 103 a sorting measure selecting menu 25 is displayed on the presentation unit 10, which is exemplarily shown in FIG. 5. The sorting measure selection menu 25 shows a number of first sorting measures 26 and a number of second sorting measures 27. The first sorting measures 26 and the second sorting measure 27 correspond to the above mentioned sorting values. A user can select a first sorting measure and a second sorting measure by using, for example, a mouse pointer and a mouse. The sorting measure selecting menu 25 comprises for the number of the first sorting measures 26 and for the number of second sorting measures 27, an increasing field 28 and a decreasing field 29. This allows a user to select an increasing sequence or a decreasing sequence of the cases with respect to the selected first sorting measure and the selected second sorting measure, respectively. Also the increasing field and the decreasing field can be selected by using the mouse pointer and the mouse.

If a user selects the Apply button or the OK button, the cases are, as described in step 104, sorted with respect to the selected first sorting measure and/or second sorting measure in the selected increasing or decreasing way. If the user selects the Apply button, the sorting measure selecting menu 25 remains open, while, if the user selects the OK button, the sorting measure selecting menu 25 is closed. If the user selects the Cancel button, the sorting measure selecting menu 25 is closed, without sorting the cases with respect to the selected first sorting measure and/or second sorting measure.

In step 104 the cases are sorted with respect to the selected first sorting measure and/or second sorting measure in the selected increasing or decreasing way. If a selection has not been carried out in step 103, the sorting is performed by using predefined sorting measures and a predefined increasing or decreasing selection. Preferentially in one embodiment, the suspiciousness is predefined, e.g., the probability of malignancy, in this embodiment. A case list is generated in accordance with the sorting values, which correspond to the selected sorting measures.

In step 105 the table 20 is presented on the presentation unit 10 including the cases in accordance with the generated case list. In step 106, the images of the case are displayed temporally successively in accordance with the generated case list in an image presentation area of the presentation unit 10. This image presentation area can, for example, be located on one or several additional monitors, being a part of the presentation unit 10. The visualization of the images in step 106 is preferentially started in one embodiment, after the user has entered a corresponding signal into the apparatus 4 for presenting cases by using the input unit 11.

Since in step 106 the images of the cases are presented in a decreasing or increasing order of, for example, breast density or probability of malignancy, e.g., suspiciousness, the complexity of the cases does not change abruptly. This helps a user, in particular, a radiologist, to maintain a certain level of operation or a certain level of attention.

If the CAD restriction button 23 has been selected, step 107 follows step 102.

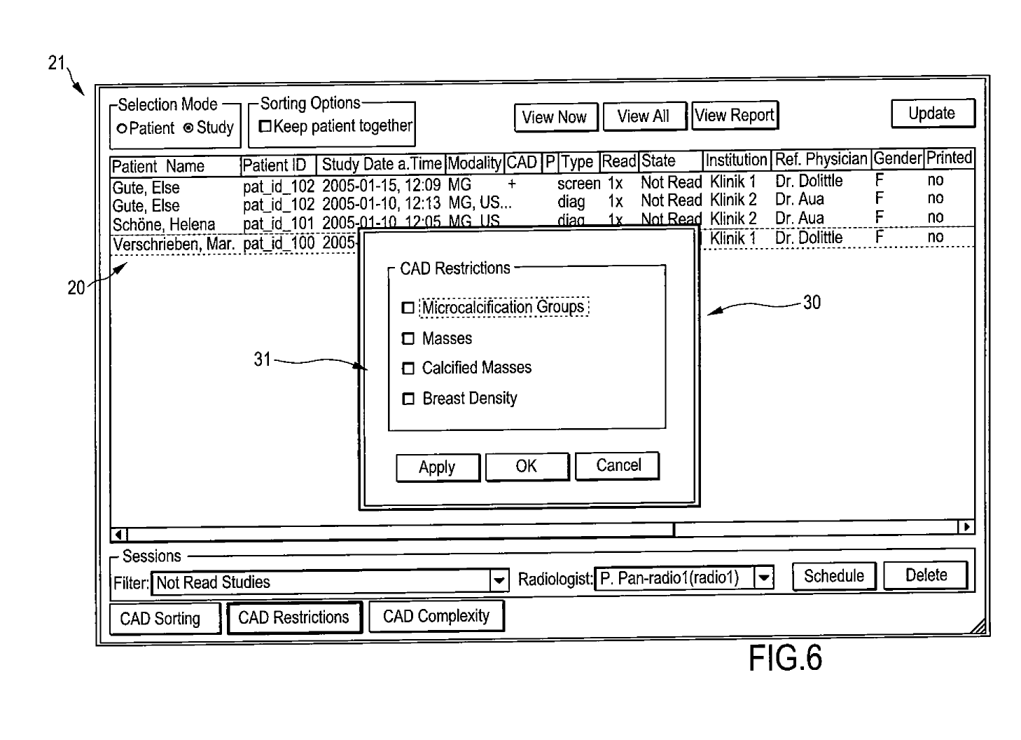

In step 107 a restriction measure selecting menu 30 is displayed on the presentation unit 10, which is exemplarily shown in FIG. 6. The restriction measure selecting menu 30 comprises several restriction measure fields 31 for selecting one or several of the restriction measures.

If one or several of these restriction measure have been selected, the restriction values, which correspond to the selected restriction measures, are determined and, in step 108, only cases are presented in the table 20, which fulfill the corresponding restriction condition.

In this embodiment, the restriction measures are microcalcification groups, masses, calcified masses and breast density. If a user selects, for example, microcalcification groups, only cases are presented in the table 20, which comprise images including CAD marks indicating microcalcification groups, e.g., only cases are presented to which microcalcification groups have been assigned. Furthermore, if a user selects masses as a restriction measure, only cases are displayed in the table 20, which comprise images including CAD marks indicating masses. If a user has selected calcified methods, in table 20 only cases are presented, which comprise images including CAD marks indicting calcified masses. If a user selects breast density as a restriction measure, only cases are presented within the table 20, which comprise images including CAD marks having a breast density, which is larger than a configurable threshold value. This configurable threshold value can be configured by a user, for example, a radiologist.

In step 109 the images of the restricted cases are presented in a presentation area temporally successively, e.g., only the images of one case are presented at the same time.

This allows a user, for example, a radiologist, to read only easy cases, e.g., cases with very low probability of cancer, in the case of medical images. This can be useful, if the user is tired or has not much experience in reading the cases. It is also possible, to restrict the presentation to very difficult cases, for example, if the corresponding images are mammograms, to restrict the presentation to cases of patients having very dense breasts.

If a user selects the CAD complexity button 24, step 110 follows step 102.

In step 110 a sorting measure selecting menu is displayed on the presentation unit 10, which differs from the sorting measure selecting menu 25, which is shown in FIG. 5, in the missing increasing fields 28 and decreasing fields 29. As described above with respect to step 103, a first sorting measure and/or a second measure can be selected by a user.

In step 111 the case list is generated such that the corresponding sorting values are evenly distributed.

A preferred procedure in one embodiment for evenly distributing the cases will in the following be exemplarily described.

In this embodiment, N is the number of cases, and to each case a certain sorting value fᵢ of the selected first sorting measure has been selected. The index i can have values from 1 to M, wherein M is the number of different sorting values fᵢ. For example, if the probability of malignancy, which is preferentially the suspiciousness in one embodiment, has been selected as the first sorting measure, the sorting value fᵢ can be the highest suspiciousness of a CAD mark within the images of the respective case. If the suspiciousness is, for example, categorized in four categories, e.g., if the suspiciousness can comprise one of four values, M is equal to 4, and the sorting values fᵢ can comprise values from 1 to 4.

Furthermore, a value Δ_{fi} is defined by following equation:

$${Δ}_{{f}_{i}} = \frac{N}{ρ ( {f}_{i} ) + 1} ,$$

with p(fᵢ) being the number of cases with the sorting value fᵢ. In the following only those Δ_{fi} are considered with p(fᵢ)≠0.

The values j·Δ_{fi}∀i=1, . . . ,M: j=1, . . . ,p(fᵢ)∀p(fᵢ)≠0 are sorted in an ascending or descending way. In the resulting sequence, e.g., in the sorted values j·Δ_{fi}, each value j·Δ_{fi} is replaced by fᵢ. Now, an evenly distributed case list is generated by replacing each fᵢ with one of the cases with feature value fᵢ, so that each case is used once in the resulting sequence of cases, e.g., in the generated case list, wherein, if different cases would occupy the same position in the case list with respect to the first sorting measure, the second sorting measure is preferentially used in the same way in one embodiment, in order to determine the order of these different cases. Furthermore, if different cases still occupy the same position within the generated list, or if the second sorting measure is not used for evenly distributing the cases, predefined rules are used to determine the order of these different cases. This predefined rule can, for example, be a random choice, the date, the alphabetical order of the respective patient names etc.

If, in another embodiment, masses have been selected as a first sorting measure, the sorting value fᵢ can be the number of mass markers in the respective case. If the number of mass markers is, for example, in general known to be smaller than 20, M is equal to 20, and the sorting values fᵢ can comprise values from 1 to 20. These sorting values and corresponding cases can evenly be distributed as explained above with respect to the suspiciousness.

In step 112 the cases are listed in table 20 in accordance with the generated case list, which has been generated in step 111. In step 113 the images of the cases are presented in an image presentation area temporally successively in accordance with the generated case list, e.g., only images of one case are presented in the image presentation area at the same time. Step 113 is preferentially carried out in one embodiment, after a user has entered a signal into the apparatus 4 for presenting cases indicating that the user wants to see the images of the cases.

Although an embodiment of a method for presenting cases in accordance with the invention has been described by describing a sequence of steps, the invention is not limited to this above described sequence. For example, the menu steps 103, 107 and 110 can be omitted and instead of selected measures, predefined measures can be used.

If in steps 104 and 111 a case list has to be generated with respect to a first sorting measure and a second sorting measure and if two or more cases would occupy the same position within the case list with respect to the first sorting measure, it is preferred in one embodiment that theses cases, which would occupy the same position within the case list, are sorted relative to each other with respect to the second sorting measure. The apparatus and the method for presenting cases can also provide more than two sorting measures, in particular, the invention is not limited to the above described number and kinds of selection values, sorting values, sorting measures and restriction measures.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A computer program may be stored/distributed on a suitable medium, such as an optical storage medium or a solid-state medium supplied together with or as part of other hardware, but may also be distributed in other forms, such as via the Internet or other wired or wireless telecommunication systems.

Any reference signs in the claims should not be construed as limiting the scope.

It is apparent for a skilled person that the features of the dependent claims can be combined and added to the features of the independent claims in accordance with the invention.

Although, some embodiments of the invention use CAD marks, these embodiments are not limited to a certain CAD algorithm, in particular, it is not important for these embodiments how these CAD marks have been determined. These embodiments assume that respective CAD marks are provided by known CAD mark generation units.

U.S. application Ser. No. ______, Attorney Docket No. 650069.402, entitled “PRESENTATION METHOD, PRESENTATION DEVICE AND COMPUTER PROGRAM FOR PRESENTING AN IMAGE OF AN OBJECT,” filed concurrently herewith, with inventors Dr. Carl J. G. Evertsz and Dr. Anke Bodicker, assigned to the same assignee as the present application, provides additional disclosure and is incorporated herein by reference in its entirety.

All of the U.S. patents, U.S. patent application publications, U.S. patent applications, foreign patents, foreign patent applications and non-patent publications referred to in this specification and/or listed in the Application Data Sheet are incorporated herein by reference, in their entireties.

1. A method for presenting cases comprising images, wherein selection values are provided, which are assigned to the cases and which are determined from the images of the respective case, wherein the presentation of the cases depends on the selection values.

2. The method as claimed in claim 1, wherein sorting values are determined depending on the selection values, wherein a case list is generated by sorting the cases according to the determined sorting values and wherein the cases are presented in accordance with the generated case list.

3. The method as claimed in claim 2, wherein the cases are medical cases, wherein the images are medical images, in particular mammograms, and wherein the sorting value is a measure for the difficulty of evaluating the cases and/or the probability of showing an illness.

4. The method as claimed in claim 2, wherein the case list is generated such that the corresponding sorting values are decreasing or increasing.

5. The method as claimed in claim 2, wherein the case list is generated such that the corresponding sorting values are evenly distributed.

6. The method as claimed in claim 2, wherein the presentation of cases comprises displaying a table in a table presentation area, wherein the table presentation area comprises a sorting button, wherein the method as claimed in claim 2 is started by activating the sorting button and wherein the table includes the cases and the selection values and/or the sorting values sorted in accordance with the generated case list.

7. The method as claimed in claim 2, wherein the presentation of cases comprises displaying a table in a table presentation area, wherein the table presentation area comprises a sorting button, wherein a sorting measure selecting menu is displayed for selecting at least one sorting measure by activating the sorting button, wherein the sorting measure selecting menu comprises an apply button and wherein the method as claimed in claim 2 is started by activating the apply button, wherein sorting values are determined which correspond to the selected sorting measures, wherein the table includes the cases and the selection values and/or the sorting values sorted in accordance with the generated case list.

8. The method as claimed in claim 7, wherein the sorting measure selecting menu comprises fields for selecting, whether the case list is generated such that the corresponding sorting values are decreasing or increasing.

9. The method as claimed in claim 6, wherein the table presentation area comprises a complexity button, wherein the method as claimed in claim 5 is started by activating the complexity button and wherein the table includes the cases and the selection values and/or the sorting values sorted in accordance with the generated case list.

10. The method as claimed in claim 2, wherein the presentation of cases comprises displaying the images of the cases temporally successively in accordance with the generated case list in an image presentation area.

11. The method as claimed in claim 1, wherein restriction values are determined depending on the selection values, wherein only cases are presented, whose restriction values fulfill a given restriction condition.

12. The method as claimed in claim 11, wherein the cases are medical cases, wherein the images are medical images, in particular mammograms, and wherein the restriction value is a measure for the difficulty of evaluating the cases and/or the probability of showing an illness.

13. The method as claimed in claim 11, wherein the presentation of cases comprises displaying a table in a table presentation area, wherein the table presentation area comprises a restriction button, wherein the method as claimed in claim 11 is started by activating the restriction button and wherein the table includes the cases, whose restriction values fulfill the given restriction condition, and the corresponding selection values and/or restriction values.

14. The method as claimed in claim 11, wherein the presentation of cases comprises displaying a table in a table presentation area, wherein the table presentation area comprises a restriction button, wherein a restriction measure selecting menu is displayed for selecting at least one restriction measure by activating the restriction button, wherein the restriction measure selecting menu comprises an apply button and wherein the method as claimed in claim 11 is started by activating the apply button, wherein restriction values are determined which correspond to the selected restriction measures, wherein the table includes the cases, whose restriction values fulfill the given restriction condition, and the corresponding selection values and/or restriction values.

15. The method as claimed in claim 11, wherein the presentation of cases comprises displaying the images of the cases, whose restriction values fulfill the given restriction condition, temporally successively in an image presentation area.

16. The method as claimed in claim 1, wherein the cases are medical cases, wherein the images are medical images, in particular mammograms, and wherein the selection values are at least on of breast density, architectural noise, number of mass marks, number of microcalcification marks, number of calcified masses, number of calcifications in a cluster, suspiciousness, number of CAD markers, number of microcalcification clusters, size of a mass marker, size of a microcalcification cluster, size of a calcified mass.

17. The method as claimed in claim 1, wherein the presentation of the cases comprises displaying the images of the cases, wherein the images comprise marks.

18. The method as claimed in claim 1, wherein sorting values are determined depending on the appearance of the images of a case, wherein a case list is generated by sorting the cases according to the determined sorting values and wherein the cases are presented in accordance with the generated case list.

19. An apparatus for presenting cases comprising images, wherein selection values have been provided, which are assigned to the cases and which have been determined from the images of the respective case, wherein the apparatus comprises a presentation unit, and wherein the apparatus is adapted for presenting the cases depending on the selection values on the presentation unit.

20. The apparatus as claimed in claim 19, wherein the apparatus comprises:
a sorting values determination unit for determining sorting values depending on the selection values,
a case list generation unit for generating a case list by sorting the cases according to the determined sorting values,
wherein the apparatus is adapted for presenting the cases in accordance with the generated case list on the presentation unit.

21. The apparatus as claimed in claim 19, further comprising a table presentation area that can be provided by the apparatus, wherein the table presentation area includes a complexity button, wherein sorting values are determined depending on the selection values, wherein a case list is generated by sorting the cases according to the determined sorting values and wherein the cases are presented in accordance with the generated case list, wherein the case list is generated such that the corresponding sorting values are evenly distributed, wherein activation of the complexity button starts said generation of the case list, an d wherein the table includes the cases and the selection values and/or the sorting values sorted in accordance with the generated case list.

22. The apparatus as claimed in claim 19, wherein the apparatus is adapted for determining restriction values depending on the selection values, wherein the presentation unit is adapted for presenting only cases whose restriction values fulfill a given restriction condition.

23. The apparatus as claimed in claim 19, wherein the cases are medical cases, wherein the images are medical images, in particular mammograms, and wherein the selection values are at least on of breast density, architectural noise, number of mass marks, number of microcalcification marks, number of calcified masses, number of calcifications in a cluster, suspiciousness, number of CAD markers, number of microcalcification clusters, size of a mass marker, size of a microcalcification cluster, size of a calcified mass.

24. An imaging system comprising:
a case generation unit for generating cases, in particular, a digital mammography device,
a selection value generation unit for generating selection values, in particular, a computer-aided-detection device,
an apparatus for presenting cases comprising images as claimed in claim 19.

25. Computer program for presenting cases comprising images, comprising program code means for causing a computer to carry out the method as claimed in claim 1 when said computer program is carried out on a computer controlling an apparatus for presenting cases comprising images, wherein selection values have been provided, which are assigned to the cases and which have been determined from the images of the respective case, wherein the apparatus comprises a presentation unit, and wherein the apparatus is adapted for presenting the cases depending on the selection values on the presentation unit.
